(19) United States
(12) Patent Application Publication
(10) Pub. No.: US 2008/0072153 A1
(43) Pub. Date: Mar. 20, 2008

(54) Method and Earphone-Microphone Device for Providing Wearable-Based Interaction

(76) Inventor: Chang-Ming Yang, Juanan Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/948,044

(22) Filed: Nov. 30, 2007

Related U.S. Application Data
(63) Continuation-in-part of application No. 11/149,391, filed on Jun. 10, 2005, now abandoned.

(51) Int. Cl. G06F 3/00

(52) U.S. Cl. 715/718

(57) ABSTRACT

An earphone-microphone device for receiving at least one physical data from a physical detector and providing wearable-based interaction between a user and a telecare system through a communication apparatus is disclosed. The earphone-microphone comprises an earphone, a microphone, and a control module. The control module is electronically connected with the earphone and the microphone respectively for receiving the at least one physical data from the physical detector. The control module comprises a receiving module, a processor, and an analyzing means. The receiving module receives the at least one physical data from the physical detector. The analyzing means determines if the received physical data exceeding a standard. When the received physical data exceeding the standard, the processor transmits the physical data to the telecare system through the communication apparatus and controls the earphone and the microphone for the user to communicate with the telecare system through the communication apparatus.

### CROSS REFERENCE

This application is a continuation-in-part (CIP) of application Ser. No. 11/149,391, filed on Jun. 10, 2005. The prior application is herewith incorporated by reference in its entirety.

### BACKGROUND OF THE INVENTION

1. Field of the Invention

The present invention relates to an earphone-microphone device, particularly relates to an earphone-microphone device for receiving at least one physical data and providing wearable-based interaction between a user and a telecare system and method thereof.

2. Description of the Related Art

Home health care is an important issue to modern life. The major problems occurred nowadays have, for example, aging population structure with fewer kids, aging workforce, overworking, pressure, or the like. These factors increase demands for health care. Moreover, the change of diet and living style results in the various chronic diseases occurred in young people. However, people are busy and having no time to go to hospital for checking health condition. So it increases demands for health care more. There is a demand for health caring but having no means to provide a simple and efficient caring service.

If a patient feels uncomfortable, usually, he/she will go to see a doctor. Normally, the doctor will check some physical data, such as temperature, heartbeat, blood pressure, blood sugar density, oxyhemoglobin and deoxygenated hemoglobin, sensor on cloths, TENS or the like, of the patient. These physical data are important for the doctor to diagnose the patient. Even more, the medical person can direct the patient how to save him/herself when in emergent situation.

For those chronic patients, for example, continuously monitoring their status can efficiently prevent sudden aggravation. The chronic patient cannot only rely on receiving medical suggestion in the clinical return visit periodically (such as every four to twelve weeks). The periodically outpatient clinical services or the long-period prescription can only provide passive defenses, instead of active controlling by doctors or telecare system for any possible serious situation of the patient. In addition, periodically outpatient services can't distribute the medical sources efficiently. Moreover, when the patient sees the doctor for clinical return visit, he/she maybe not having any aggravation symptom at that moment. Thus, the doctor could not provide an efficient therapy.

In some articles, for example, in Journal of Evaluation in Clinical Practice, Volume 13, Number 3, June 2007, pp. 346-351(6), it describes “We enrolled 77 patients who were predominantly male (68%), elderly (median age 65 years) and chronically ill (median number of co-morbidities=3). The interactive voice response system (IVRS) reached 45 of the 77 patients (58.4%). Forty patients (51.9%) answered all questions on the survey. Twenty patients (26%, 95% CI 17%-37%) indicated new or worsening symptoms, problems with their medications, or requested to talk to the clinic nurse. For 10 patients (13%, 95% C17%-22%), the IVRS could have made a difference in their outcome”. It is obvious that the interactive voice response system (IVRS) could improve post-discharge monitoring.

Therefore, it is important to provide a device that can provide wearable-based interaction between a user (patient) and a telecare system, which helps the patient to get professional suggestions and evaluations from the telecare system immediately in order to create the environment of “hospital without walls”.

### SUMMARY OF THE INVENTION

One aspect of the present invention is to solve the above-mentioned problem. Therefore, the present invention provides a method and an earphone-microphone device for receiving at least one physical data and providing wearable-based interaction between a user and a telecare system. Furthermore, it can efficiently distribute the medical source. Therefore, the user (or the patient) can be taken care by the telecare system no matter where the user is.

Additional aspects of the invention will be set forth in the description which follows, and in part will be apparent from the description, or may be learned by practice of the invention.

The present invention provides an earphone-microphone device for receiving at least one physical data from a physical detector and providing wearable-based interaction between a user (or a patient) and a telecare system through a communication apparatus. The earphone-microphone comprises an earphone, a microphone, and a control module. The control module is electronically connected with the earphone and the microphone respectively for receiving the at least one physical data from the physical detector. The control module comprises a receiving module, a processor, and an analyzing means. The receiving module receives the at least one physical data from the physical detector. The analyzing means determines if the received physical data exceeding a standard. When the received physical data exceeding the standard, the processor transmits the physical data to the telecare system through the communication apparatus and controls the earphone and the microphone for the user to communicate with the telecare system through the communication apparatus. Moreover, the device of the earphone or microphone can be set on anywhere, as long as the user can hear the voice from the earphone or speak to the microphone.

In another embodiment, the analyzing means determines if a request signal is received. When the request signal is received, the processor transmits the physical data to the telecare system through the communication apparatus and controls the earphone and the microphone for the user to communicate with the telecare system through the communication apparatus. The control module comprises a voice recognition program stored in the memory for analyzing voice of the user. When the user uses the microphone of the present invention, the analyzing means can determine the intensity or tone or speed or words of the speaking of the user so that the processor controls the earphone and the microphone for the user to communicate with the telecare system through the communication apparatus. Moreover, the control module also has recording and playing function so the earphone and the microphone can communicate automatically with the user. For example, every morning the earphone plays with “how are you today? If you feel good please say yes, if you feel bad please say no”. When the user says “no”, the earphone-microphone device will recognize and ask next question to the user, such as “do you eat the drug for highpertension? If you eat please say yes, if you did not please say no”. If the user says “no”, the earphone will further play with “please eat the drug now”. If the user says “yes” the earphone will play with “check the blood pressure now” and the controller controls to transmit the received physical data to the telecare system.

A doctor can analyze voice of a patient. For instance, when the user is sick, the intensity of sound is weak. The speaking of asthma patient is quicker than normal situation. When the user is under depression, the words of talking are negative. In the other way, when the user is getting married, the feeling of the user is positive. Therefore, the recorded voice can be sent to the telecare system for further analyzing.

The earphone-microphone device further comprises a screen connected with the control module for displaying the received physical data. For example, when the user is fever, the screen can show “37.5”, it's very useful for the deaf man. Furthermore, when the device asks the question, for example, the device asks the question “how are you today? If you feel good please push the left button if you feel bad please push the right button” it is useful for the mute person. Some buttons even can be replaced by the rocking bar handle or scroll wheel which just like a scroll on the earphone, or the like. Moreover, when the device ask the question by the screen with some buttons, for example, when the user hear the questions and see the questions and then along with the questions to answer by talking or push the button to answer.

In one embodiment, the physical detector is a temperature sensor or a head posture sensor, such as accelerometer, disposed in the earphone. When the detector is a temperature sensor, the physical data is the temperature of the user. When the detector is a head posture sensor, the physical data is the position, such as the head turn left or right, of the user

In another embodiment, the earphone-microphone device comprise a wireless receiving module connected with the processor for wirelessly receiving the physical data from the physical detector, such as a stethoscope, a sphygmomanometer, a glucometer, bodyfat detector, lung function detector, ultrasound system device, oxyhemoglobin meter, electrocardiography, heart rate variability (HRV) device, or the like.

In yet another embodiment, the earphone-microphone device comprises a connector connected with the receiving module for electronically connected with the physical detector, such as a stethoscope, a sphygmomanometer, a glucometer, bodyfat detector, lung function detector, ultrasound system device, oxyhemoglobin meter, electrocardiography, heart rate variability (HRV) device, or the like. In this embodiment, the earphone-microphone device comprises a control case, wherein the connector and the control module are disposed in the control case.

In a preferred embodiment, the control module comprises a memory connected with the processor for storing the physical data. In addition, the memory can store the time data when the physical data is detected. The record of the physical data can be accessed using a memory card. In this embodiment, the control module may further comprise an input-output controller connected with the memory and the analyzing means for transmitting the physical data to the communication apparatus. The input-output controller can be used for receiving the standard when a different user is using the earphone-microphone device. Furthermore, the input-output controller may control the memory to be accessed by the communication apparatus. Moreover, the input-output controller can be complied with IEEE802.11 a/b/g/n, Bluetooth, ZigBee, UWB, WiMax, or the like. When necessary, the physical data can be sent wirelessly.

Preferably, the input-output controller receives the standard for the analyzing means to determine, or reset for different user.

Preferably, the present invention further comprises an alarm element electronically connected with the control module, when the received physical data exceeding the standard, the processor controls the alarm element to alarm. The alarm element comprises an alarm button, an alarm joystick, or an adjustment electronically connected with the control module for controlling the earphone and the microphone for the user to communicate with the telecare system through the communication apparatus. The alarm element may comprise an alarm light electronically connected with the control module for lighting.

In one embodiment, the control module may further comprise an RFID tag connected with the input-output controller for the communication apparatus to identify the user. Alternatively, the control module may further comprise an RFID tag connected with the memory and the analyzing means respectively for transmitting the physical data and for the communication apparatus to identify the user.

In addition, the present invention provides a method for providing wearable-based interaction between a user and a telecare system through a communication apparatus. The method comprises:

receiving at least one physical data from a physical detector;

comparing the received physical data with a standard;

transmitting the received physical data when the received physical data exceeds the standard; and

determining to activate the physical detector or to start a communication between the user and the telecare system through the communication apparatus.

In one embodiment, the telecare system can require the user to send the physical data actively. For example, when a doctor wants to know the condition of a patient who just had a operation, and the doctor can immediately inquire about the patient's physical condition by talking with the patient or getting the patient's physical data through the earphone-microphone device.

In one embodiment, to activate the physical detector is to start the physical detector periodically according to the comparing of the received physical data with the standard. For example, when the temperature of the user is higher than the standard only 1□, the method according to the present invention is to activate the physical detector in every 2 hours. If the temperature of the user is higher than the standard only 3.5□, the method according to the present invention is to start the communication between the user and the telecare system through the communication apparatus. That is, the method may determine if the difference between the received physical data and the standard exceeding than a predetermined value for controlling the communication or detection. In another embodiment, the method further comprises activating an alarm element when the received physical data exceeds the standard.

Preferably, the method according to the present invention may further comprise storing the received physical data.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is an architecture diagram of an earphone-microphone device used for receiving at least one physical data from a physical detector and providing wearable-based interaction between a user and a telecare system through a communication apparatus according to an embodiment of the present invention.

FIG. 2 shows schematic view of earphone-microphone device according to an embodiment of the present invention.

FIG. 2A shows schematic view of earphone-microphone device according to another embodiment of the present invention.

FIG. 3 shows a schematic diagram of a control module of an earphone-microphone device according to the present invention.

FIG. 3A shows a schematic diagram of a part of a control module according to the present invention.

FIG. 4 shows schematic view of earphone-microphone device according to yet another embodiment of the present invention.

FIG. 5 shows a process flow chart of a method for providing wearable-based interaction between a user and a telecare system through a communication apparatus in accordance with the present invention.

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. Like reference numerals in the drawings denote like elements.

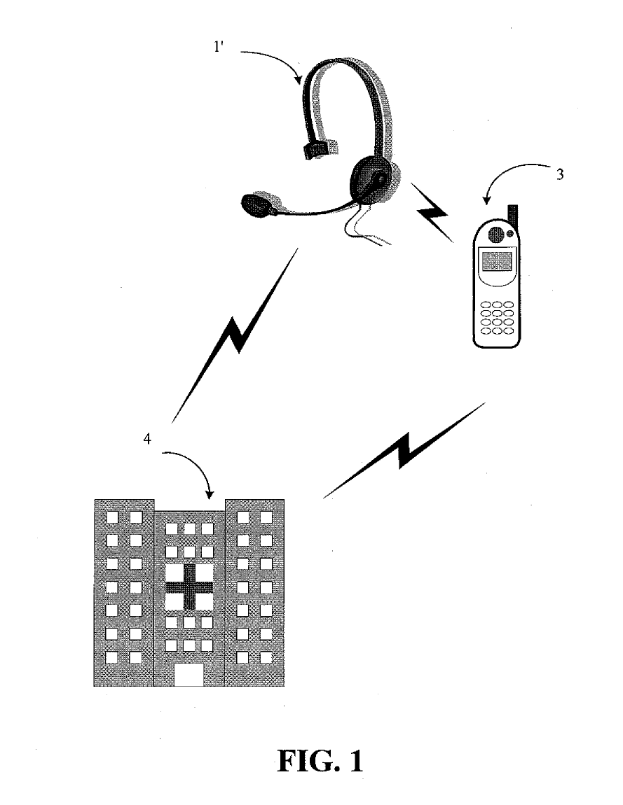

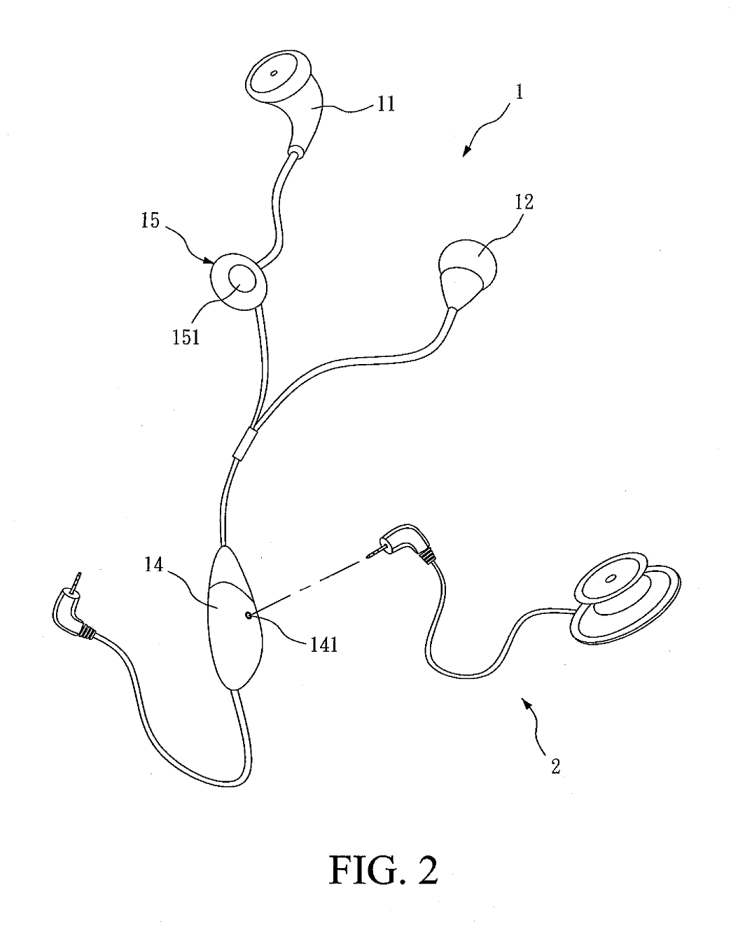

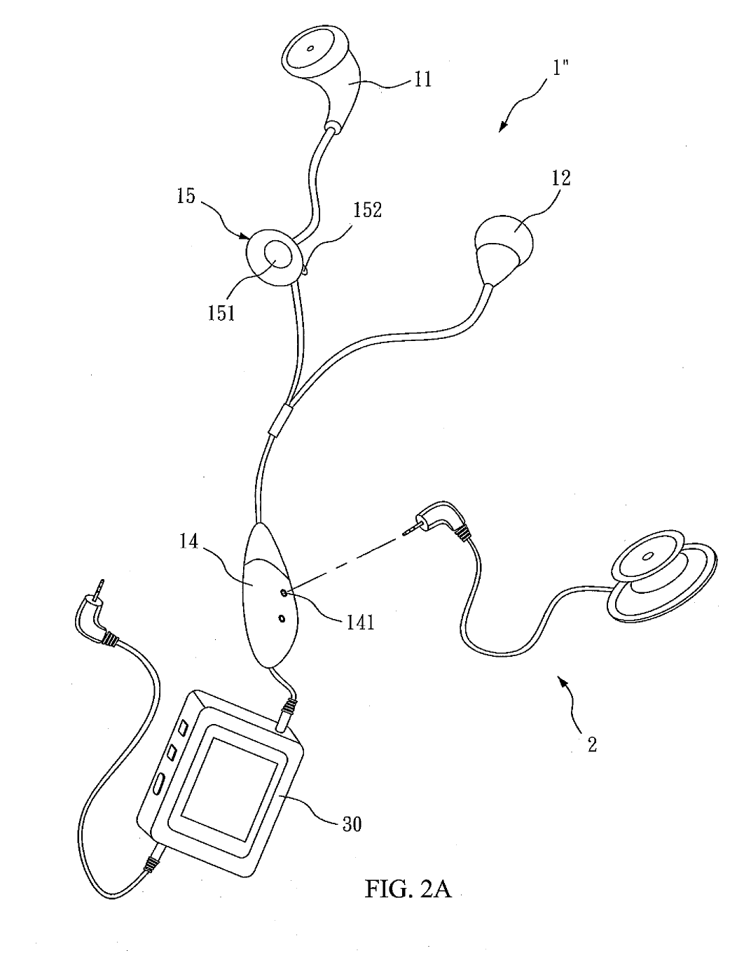

Referring to FIG. 1 and FIG. 2, the present invention provides an earphone-microphone device 1′ or 1 for receiving at least one physical data from a physical detector 2 and providing wearable-based interaction between a user (or a patient who uses the earphone-microphone device 1′ or 1) and a telecare system 4, such as a remote medical person, a doctor, a medical center, or the like, through a communication apparatus 3. The communication apparatus 3 can be a mobile phone, computer, PDA, wireless device, internet-connectable device, or the like.

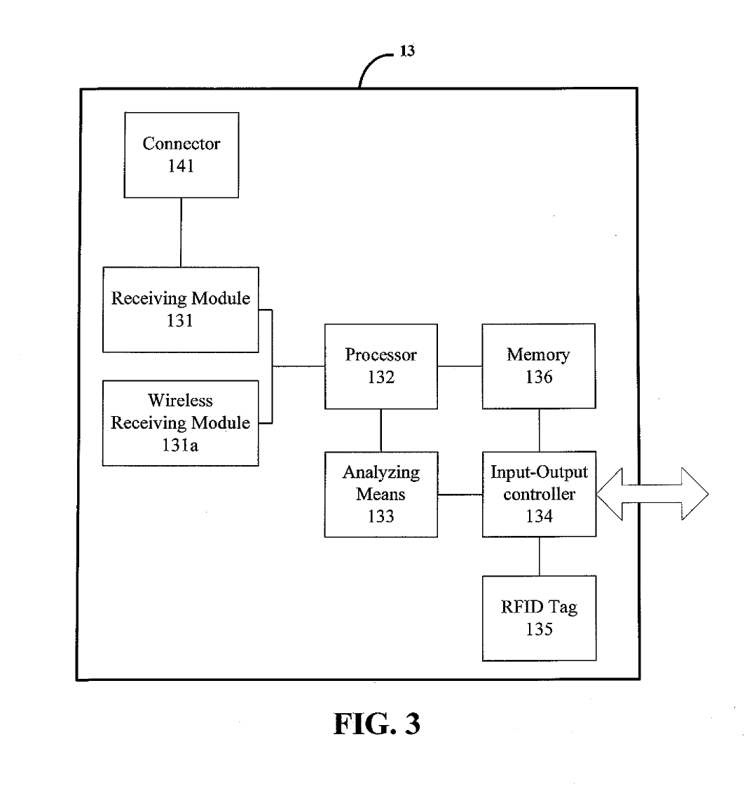

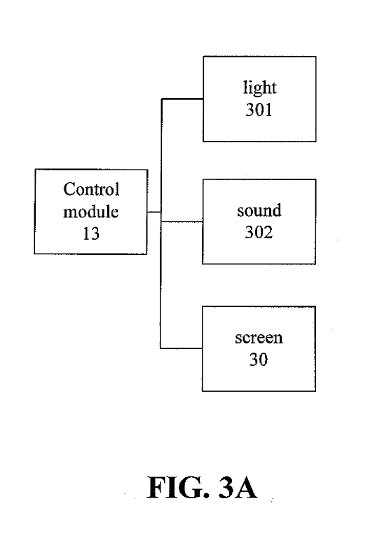

Please refer to FIG. 2 and FIG. 3. The earphone-microphone 1 comprises an earphone 11, a microphone 12, and a control module 13 electronically connected with the earphone 11 and the microphone 12 respectively. The control module 13 may be disposed in the earphone 11 or the microphone 12. Alternatively, the earphone-microphone device 1 may further comprise a control case 14, wherein the control module 13 is disposed in the control case 14.

The control module 13 is electronically connected with the earphone 11 and the microphone 12 respectively for receiving the at least one physical data from the physical detector 2. The control module 13 comprises a receiving module 131, a processor 132, and an analyzing means 133. The receiving module 131 receives the at least one physical data from the physical detector 2, such as a stethoscope, a sphygmomanometer, a glucometer, bodyfat detector, lung function detector, ultrasound system device, oxyhemoglobin meter, electrocardiography, heart rate variability (HRV) device, or the like. The analyzing means 133 determines if the received physical data exceeding a standard that can be set by a doctor according to different users, for example. When the received physical data exceeds the standard, the processor 132 transmits the physical data to the telecare system 4 through the communication apparatus 3 and controls the earphone 11 and the microphone 12 for the user to communicate with the telecare system 4 through the communication apparatus 3. The connection between the earphone-microphone 1 and the communication apparatus 3 can be wired or wireless.

In another embodiment, the analyzing means 133 determines if a request signal is received. When the request signal is received, the processor 132 transmits the physical data to the telecare system 4 through the communication apparatus 3 and controls the earphone 11 and the microphone 12 for the user to communicate with the telecare system 4 through the communication apparatus 3. For example, when the control module did not receive the physical data because of noise interruption or the incorrect position of the physical detector, the control module will alarm the user first and if the condition may be solved by the user, the alarm will be stopped. An alarm element 15 will be described more detail in the following showing in FIG. 2A.

In another embodiment, if the telecare system 4 can not receive the physical data transmitted by the control module 13 on time, the telecare system 4 can send a request signal to the earphone-microphone device 1. For example, when the telecare system 4 does not receive any physical data for a specific time, it transmits a request signal to the earphone-microphone device 1 of the present invention. When the earphone-microphone device 1 receives the request signal, the processor 132 transmits the physical data to the telecare system 4 through the communication apparatus 3 and controls the earphone 11 and the microphone 12 for the user to communicate with the telecare system 4 through the communication apparatus 3.

That is, the analyzing means 133 determines if a request signal is received, when the request signal is received, the processor 132 transmits the physical data to the telecare system 4 through the communication apparatus 3 and controls the earphone 11 and the microphone 12 for the user to communicate with the telecare system 4 through the communication apparatus 3.

Moreover, when the user uses the microphone 12, the analyzing means 133 can determine the frequency of the speaking of the user so that the processor 132 controls the earphone 11 and the microphone 12 for the user to communicate with the telecare system 4 through the communication apparatus 3.

In one embodiment, the physical detector is a temperature sensor or a head posture sensor (not sown) disposed in the earphone 11. When the physical detector is a temperature sensor, the physical data is the temperature of the user. When the detector is a head posture sensor, the physical data is the position, such as sitting or standing, of the user.

In another embodiment, the control module 13 comprises a wireless receiving module 131a connected with the processor 132 for wirelessly receiving the physical data from the physical detector, such as a stethoscope 2, a sphygmomanometer, a glucometer, bodyfat detector, lung function detector, ultrasound system device, oxyhemoglobin meter, electrocardiography, heart rate variability (HRV) device, or the like.

In yet another embodiment, the earphone-microphone device 1 comprises a connector 141 connected with the receiving module 131. The connector 141 can be electronically connected with the physical detector, such as a stethoscope, a sphygmomanometer, a glucometer, bodyfat detector, lung function detector, ultrasound system device, oxyhemoglobin meter, electrocardiography, heart rate variability (HRV) device, or the like. Preferably, the connector 141 may also be disposed in the control case 14.

In a preferred embodiment, the control module 13 comprises a memory 136 connected with the processor 132 for storing the physical data. The record of the physical data can be accessed using a memory card, for example. In this embodiment, the control module 13 may further comprise an input-output controller 134 connected with the memory 136 and the analyzing means 133 for transmitting the physical data to the communication apparatus 3. Furthermore, the input-output controller 134 may control the memory 136 to be accessed by the communication apparatus 3. The input-output controller 134 can be used for receiving the standard when a different user is using the earphone-microphone device.

Moreover, the input-output controller 134 can be complied with IEEE802.11 a/b/g/n, Bluetooth, ZigBee, UWB, WiMax, or the like. The physical data can be sent wirelessly through the input-output controller 134 so that the physical data can be transmitted wirelessly and directly to the telecare system 4. Preferably, the input-output controller 134 receives the standard for the analyzing means 133 to determine the received physical data, or reset for different user.

The control module 13 may comprise a voice recognition program stored in the memory 136 for analyzing voice of the user in order to understand the user's condition.

Preferably, as shown in FIG. 2, the present invention further comprises an alarm element 15 electronically connected with the control module 13. When the received physical data exceeds the standard, the processor 132 controls the alarm element 15 to alarm. Alternatively, the alarm element 15 comprises an alarm button 151, or an alarm joystick (not shown), or an adjustment (not shown) electronically connected with the control module 13 for controlling the earphone 11 and the microphone 12 for the user to communicate with the telecare system 4 through the communication apparatus 3. For example, when the user feels very uncomfortable, the user can use the alarm button 151 (or the alarm joystick, or the adjustment) to activate the earphone 11, the microphone 12, and the communication apparatus 3 for the communication with the telecare system 4.

The alarm element 15 may further comprise an alarm light 152 or vibrating or sound to make the user awareness.

In one embodiment, as showing in FIG. 3, the control module 13 may further comprise an RFID tag 135 connected with the input-output controller 134 for the communication apparatus 3 to identify the user.

Please refer to FIG. 2A and FIG. 3A. The earphone-microphone device 1″ may further comprise a screen 30 connected with the control module 13 for displaying the received physical data. For example, when the user is fever, the screen 30 can show “38.0”. it's very useful for the deaf man. Furthermore, when the screen 30 may show questions, such as “how are you today? If you feel good please push the left button if you feel bad please push the right button”. It is useful for the mute person.

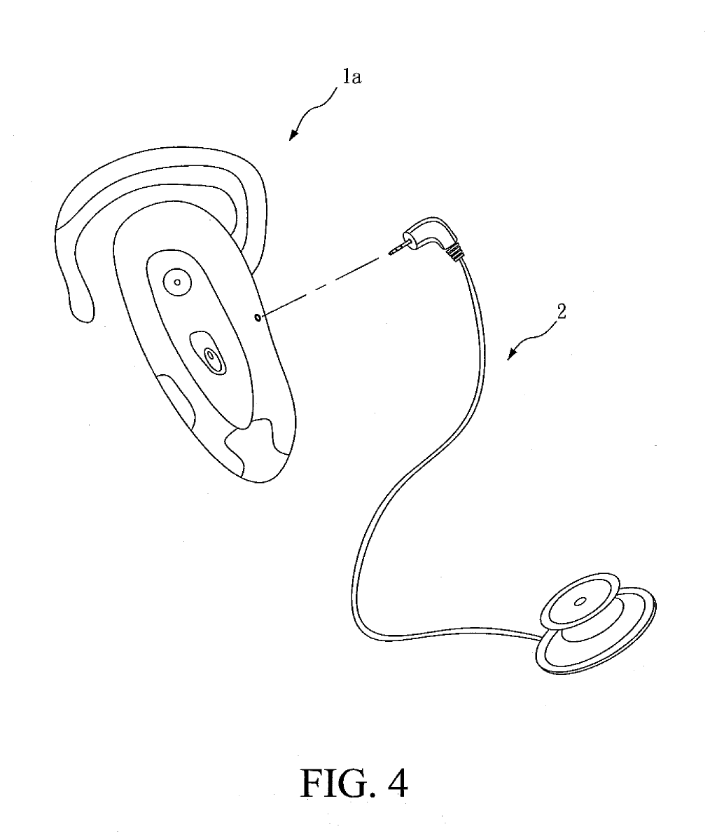

Moreover, as shown in FIG. 4, the earphone-microphone device 1a of the present invention may be wirelessly connecting with the communication apparatus 3. Furthermore, though the physical detector 2 shows wired connecting to the earphone-microphone device 1a, it can be wireless. The figures are not used to limit the present invention.

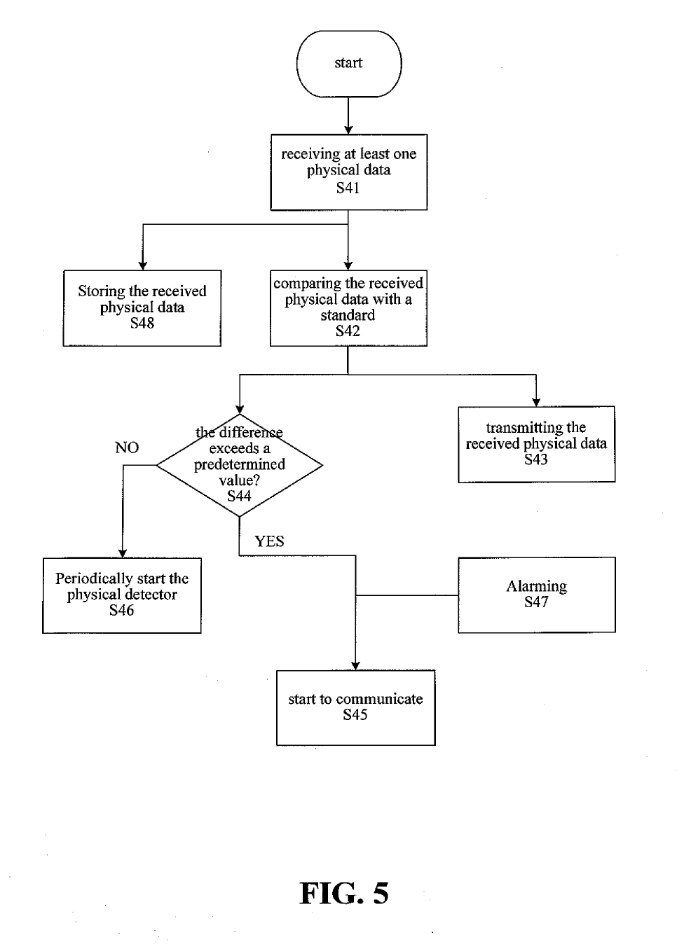

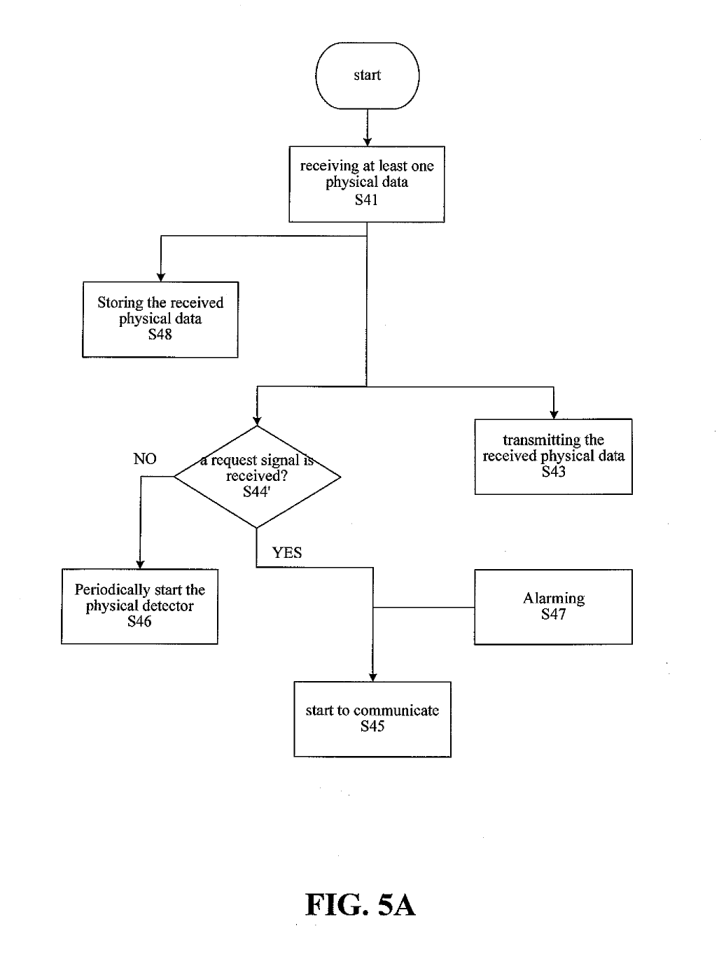

For example, when the PDA connects with the earphone-microphone device, the memory can be removed from the device to the PDA. Thus, the space of memory of earphone-microphone device can use repeatedly because the memory can be removed when the device connect with the PDA or a computer, or the telecare system. Also the doctor can indicate the user to use the physical detector by video-communication of PDA or Web-cam. For example, the doctor can see the user uses the telescope to set left or right chest correctly. In addition, the present invention provides a method for providing wearable-based interaction between a user and a telecare system through a communication apparatus. Please refer to FIG. 5. After start, i.e. a user start to use the earphone-microphone device 1 as described above, the method comprises S41: receiving at least one physical data from a physical detector; then, S42: comparing the received physical data with a standard. Preferably, the method can store the received physical data (S48).

After receiving the physical data, the method comprises S43: transmitting the received physical data when the received physical data exceeds the standard; and S44: determining to activate the physical detector or to start a communication between the user and the telecare system through the communication apparatus.

In one embodiment, to activate the physical detector is to start the physical detector periodically according to the comparing of the received physical data with the standard. For example, when the temperature of the user is higher than the standard only 1□, the method according to the present invention is to activate the physical detector in every 2 hours. If the temperature of the user is higher than the standard only 3.5□, the method according to the present invention is to start the communication between the user and the telecare system through the communication apparatus. In another word, the method comprises S44: determining if the difference between the received physical data and the standard exceeds a predetermined value for controlling the communication or detection. If the determination is “YES”, then the process comes to S45: start to communicate, i.e. the user can use the earphone-microphone device to communicate with the telecare system 4 via the communication apparatus 3. If the determination is “NO”, then the process comes to S46: periodically starts the physical detector, such as activating the physical detector in every 2 hours.

In another embodiment, the method further comprises S47: activating an alarm element when the received physical data exceeds the predetermined value, so the user may understand that he/she is ill.

Alternatively, please refer to the FIG. 5A. The step of S42 of FIG. 5 can be omitted. Instead, step of S44″ is: transmitting the received physical data when a request signal is received. When the request signal is received, then to process the S45, S46, or S47 as described above.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. An earphone-microphone device for receiving at least one physical data from a physical detector and providing wearable-based interaction between a user and a telecare system through a communication apparatus, the earphone-microphone device comprising:
an earphone;
a microphone; and
a control module comprising a receiving module, a processor, and an analyzing means, the control module electronically connected with the earphone and the microphone respectively,
wherein the receiving module receives the at least one physical data from the physical detector, the analyzing means determines if the received physical data exceeding a standard, when the received physical data exceeds the standard, the processor transmits the physical data to the telecare system through the communication apparatus and controls the earphone and the microphone for the user to communicate with the telecare system through the communication apparatus.

2. The earphone-microphone device of claim 1, wherein the physical detector can be a temperature sensor or a head posture sensor disposed in the earphone.

3. The earphone-microphone device of claim 1 further comprising a wireless receiving module % connected with the processor for wirelessly receiving the physical data from the physical detector.

4. The earphone-microphone device of claim 1 further comprising a connector connected with the receiving module for electronically connected with the physical detector for receiving the physical data from the physical detector.

5. The earphone-microphone device of claim 4 further comprising a control case, wherein the connector and the control module are disposed in the control case.

6. The earphone-microphone device of claim 1, wherein the control module comprises an input-output controller connected with the analyzing means for transmitting the physical data to the communication apparatus, and the input-output controller connected with the analyzing means for receiving the standard.

7. The earphone-microphone device of claim 6, wherein the input-output controller is complied with IEEE802.11 a/b/g/n, Bluetooth, ZigBee, UWB, or WiMax.

8. The earphone-microphone device of claim 6, wherein the control module comprises an RFID tag connected with the input-output controller for the communication apparatus to identify the user.

9. The earphone-microphone device of claim 1, wherein the control module comprises a memory connected with the processor for storing the physical data.

10. The earphone-microphone device of claim 9, wherein the control module comprises a voice recognition program stored in the memory for analyzing voice of the user.

11. The earphone-microphone device of claim 1 further comprising an alarm element electronically connected with the control module, when the received physical data exceeding the standard, the processor controls the alarm element to alarm.

12. The earphone-microphone device of claim 11, wherein the alarm element comprises an alarm button, an alarm joystick, or an adjustment electronically connected with the control module for controlling the earphone and the microphone for the user to communicate with the telecare system through the communication apparatus.

13. The earphone-microphone device of claim 12, wherein the alarm element comprises an alarm light electronically connected with the control module for lighting

14. The earphone-microphone device of claim 1, wherein the control module comprises an RFID tag connected with the memory and the analyzing means for transmitting the physical data and for the communication apparatus to identify.

15. The earphone-microphone device of claim 1, wherein the control module can be disposed in the earphone or the microphone.

16. The earphone-microphone device of claim 1, wherein the communication apparatus is a mobile phone, computer, PDA, wireless device or internet-connectable device.

17. The earphone-microphone device of claim 1 further comprising a screen connected with the control module for displaying the received physical data.

18. An earphone-microphone device for receiving at least one physical data from a physical detector and providing home-based interaction between a user and a telecare system through a communication apparatus, the earphone-microphone device comprising:
an earphone;
a microphone; and
a control module comprising a receiving module, a processor, and an analyzing means, the control module electronically connected with the earphone and the microphone respectively,
wherein the receiving module receives the at least one physical data from the physical detector, the analyzing means determines if a request signal is received, when the request signal is received, the processor transmits the physical data to the telecare system through the communication apparatus and controls the earphone and the microphone for the user to communicate with the telecare system through the communication apparatus.

19. A method for providing wearable-based interaction between a user and a telecare system through a communication apparatus, the method comprising:
receiving at least one physical data from a physical detector;
comparing the received physical data with a standard;
transmitting the received physical data when the received physical data exceeds the standard; and
determining to activate the physical detector or to start a communication between the user and the telecare system through the communication apparatus.

20. The method of claim 19, wherein to activate the physical detector is to start the physical detector periodically according to the comparing of the received physical data with the standard.

21. The method of claim 19 further comprising:
storing the received physical data.

22. The method of claim 19 further comprising:
activating an alarm element when the received physical data exceeds the standard.

23. A method for providing wearable-based interaction between a user and a telecare system through a communication apparatus, the method comprising:
receiving at least one physical data from a physical detector;
transmitting the received physical data when a request signal is received; and
determining to activate the physical detector or to start a communication between the user and the telecare system through the communication apparatus.

24. The method of claim 23, wherein to activate the physical detector is to start the physical detector periodically according to the comparing of the received physical data with the standard.

25. The method of claim 24 further comprising:
storing the received physical data.

26. The method of claim 23 further comprising:
activating an alarm element when the received physical data exceeds the standard.
